(19) United States
(12) Patent Application Publication
(10) Pub. No.: US 2026/0155605 A1
(43) Pub. Date: Jun. 4, 2026

(54) RELEASE CABLE FOR CHARGING LOCK ASSEMBLY OF A CHARGING INLET ASSEMBLY

(71) Applicant: TE Connectivity Solutions GmbH, Schaffhausen (CH)

(72) Inventors: Joshua T. Shoemaker, Winston Salem, NC (US); Joel Plasencia, Winston Salem, NC (US); Kevin John Peterson, Winston Salem, NC (US); Matthew Bryan Hitchcock, Middletown, PA (US)

(21) Appl. No.: 19/085,088

(22) Filed: Mar. 20, 2025

Related U.S. Application Data
(60) Provisional application No. 63/726,887, filed on Dec. 2, 2024.

(51) Int. Cl. H01R 13/633; B60L 53/16; H01R 13/627

(52) U.S. Cl. CPC H01R 13/633; B60L 53/16; H01R 13/6278; H01R 2201/26

(57) ABSTRACT

A charging lock assembly for a charging inlet assembly includes a charging lock housing having a cavity with a charging lock pin in the cavity configured to lock a charging connector to the charging inlet assembly during charging as the charging lock pin is moved between a locked position and an unlocked position. The charging lock assembly includes a release assembly having a release lever operably coupled to the charging lock pin to release the charging lock pin from the locked position to the unlocked position. The release assembly includes a release cable coupled to the release lever to actuate the release lever and a cable adapter supporting the release cable. The cable adapter has a cable channel receiving the release cable.

### CROSS REFERENCE TO RELATED APPLICATIONS

This application claims benefit to US Application No. 63/726,887, filed 02-Dec.-2024, titled “RELEASE CABLE FOR CHARGING LOCK ASSEMBLY OF A CHARGING INLET ASSEMBLY” the subject matter of which is herein incorporated by reference in its entirety.

### BACKGROUND OF THE INVENTION

The subject matter herein relates generally to vehicle charging systems.

Charging inlet assemblies are used to charge vehicles, such as for charging a battery system of an electric vehicle (EV) or hybrid electric vehicle (PHEV). The charging inlet assembly includes charging terminals held by a housing of the charging inlet assembly. A charging plug is plugged into the charging inlet assembly to charge the electric vehicle. For safety, the charging inlet assembly includes a charging lock to lock the charging plug in the charging inlet assembly during charging. The charging lock is electrically actuated. If the charging lock malfunctions, the charging plug may be locked to the charging inlet assembly leaving the electric vehicle tethered to the charging station. Manufacturers make provision for a manual release cable to manually release the charging plug. However, the manual release cable may become improperly aligned or positioned, leading to failure of the manual release cable. For example, the end of the manual release cable is typically held by a metal bracket, which may become bent or misaligned relative to the housing leading to improper operation or failure. The manual release cable may be difficult to assemble.

A need remains for an improved manual release cable design for a charging inlet assembly.

### BRIEF DESCRIPTION OF THE INVENTION

In one embodiment, a charging lock assembly for a charging inlet assembly of a vehicle is provided. The charging lock assembly includes a charging lock housing that has a cavity. The charging lock assembly includes a charging lock pin in the cavity of the charging lock housing. The charging lock pin is configured to lock a charging connector to the charging inlet assembly during charging. The charging lock assembly includes a charging lock actuator operably coupled to the charging lock pin configured to move the charging lock pin between a locked position and an unlocked position. The charging lock assembly includes a release assembly includes a release lever operably coupled to the charging lock pin to release the charging lock pin from the locked position to the unlocked position. The release assembly includes a release cable coupled to the release lever to actuate the release lever, and the release assembly includes a cable adapter supporting the release cable. The cable adapter has a cable channel receiving the release cable.

In a further embodiment, a charging inlet assembly is provided and includes a charging inlet housing that has a front and a rear. The charging inlet housing has terminal channels between the front and the rear. The charging inlet housing is configured to be coupled to a charging connector at the front. The charging inlet assembly includes charging terminals received in the corresponding terminal channels and are held in the charging inlet housing. The charging terminals have mating ends and terminating ends. The terminating ends are configured to be electrically coupled to corresponding power cables. The mating ends include pins configured to be connected to the charging connector. The charging inlet assembly includes a charging lock assembly configured to lock the charging connector to the charging inlet assembly during charging. The charging lock assembly includes a charging lock housing coupled to the charging inlet housing and has a cavity. The charging lock assembly includes a charging lock pin in the cavity of the charging lock housing. The charging lock pin is configured to lock the charging connector to the charging inlet assembly during charging. The charging lock assembly includes a charging lock actuator operably coupled to the charging lock pin configured to move the charging lock pin between a locked position and an unlocked position. The charging lock assembly includes a release assembly includes a release lever operably coupled to the charging lock pin to release the charging lock pin from the locked position to the unlocked position. The release assembly includes a release cable coupled to the release lever to actuate the release lever. The release assembly includes a cable adapter supporting the release cable. The cable adapter includes a cable channel receiving the release cable.

In a further embodiment, a release assembly for releasing a charging lock pin used to lock a charging connector to a charging inlet assembly during a charging operation is provided. The release assembly includes a release lever movable between an unactuated position and an actuated position. The release lever is configured to be operably coupled to the charging lock pin to release the charging lock pin from a locked position to an unlocked position as the release lever is moved from the unactuated position to the actuated position. The release assembly includes a release cable coupled to the release lever to actuate the release lever. The release assembly includes a cable adapter supporting the release cable. The cable adapter includes a cable channel receiving the release cable. The cable adaptor positions the release cable relative to the release lever.

### BRIEF DESCRIPTION OF THE DRAWINGS

FIG. 1 is a front perspective view of a charging inlet assembly in accordance with an exemplary embodiment.

FIG. 2 is a rear perspective view of the charging inlet assembly in accordance with an exemplary embodiment showing a manual release assembly of a charging lock assembly in a home or released position.

FIG. 3 is a rear perspective view of the charging inlet assembly in accordance with an exemplary embodiment showing the manual release assembly of the charging lock assembly in an emergency or pulled position.

FIG. 4 is a top perspective view of a portion of the charging lock assembly showing the cable adapter in accordance with an exemplary embodiment.

FIG. 5 is a top perspective view of the cable adapter in accordance with an exemplary embodiment.

FIG. 6 is a bottom perspective view of the cable adapter in accordance with an exemplary embodiment.

FIG. 7 is a front perspective view of the cable adapter in accordance with an exemplary embodiment.

FIG. 8 is a side view of the charging lock assembly in accordance with an exemplary embodiment.

FIG. 9 is a sectional view of a portion of the charging inlet assembly showing the charging lock assembly coupled to the charging inlet housing in accordance with an exemplary embodiment.

FIG. 10 is a side view of a portion of the charging inlet assembly showing the charging lock assembly poised for coupling to the mount in accordance with an exemplary embodiment.

FIG. 11 is a side view of a portion of the charging inlet assembly showing the manual release cable of the charging lock assembly in a home or released position in accordance with an exemplary embodiment.

FIG. 12 is a side view of a portion of the charging inlet assembly showing the manual release cable of the charging lock assembly in an emergency or pulled position in accordance with an exemplary embodiment.

FIG. 13 is a top perspective view of the cable adapter in accordance with an exemplary embodiment.

FIG. 14 is a side perspective view of the cable adapter in accordance with an exemplary embodiment.

FIG. 15 is a front perspective view of the cable adapter in accordance with an exemplary embodiment.

FIG. 16 is a side view of a portion of the charging inlet assembly showing the manual release cable of the charging lock assembly in a home or released position in accordance with an exemplary embodiment.

FIG. 17 is a side view of a portion of the charging inlet assembly showing the manual release cable of the charging lock assembly in an emergency or pulled position in accordance with an exemplary embodiment.

### DETAILED DESCRIPTION OF THE INVENTION

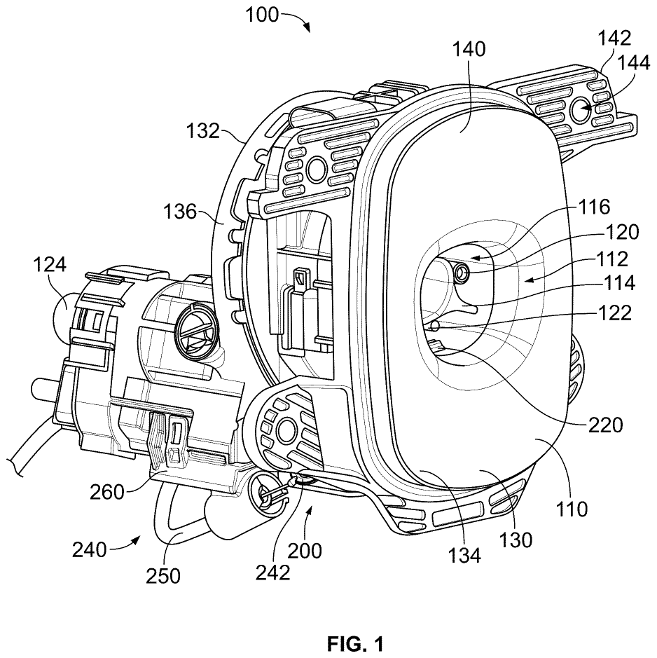

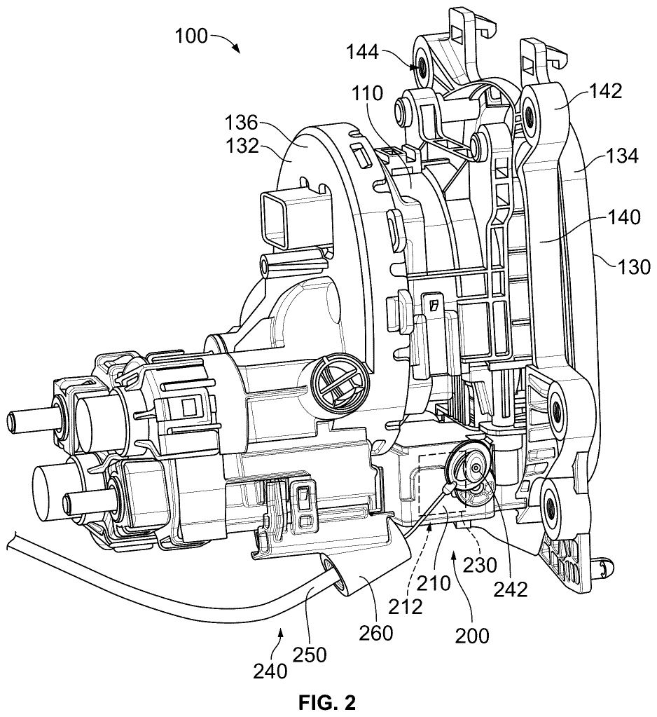

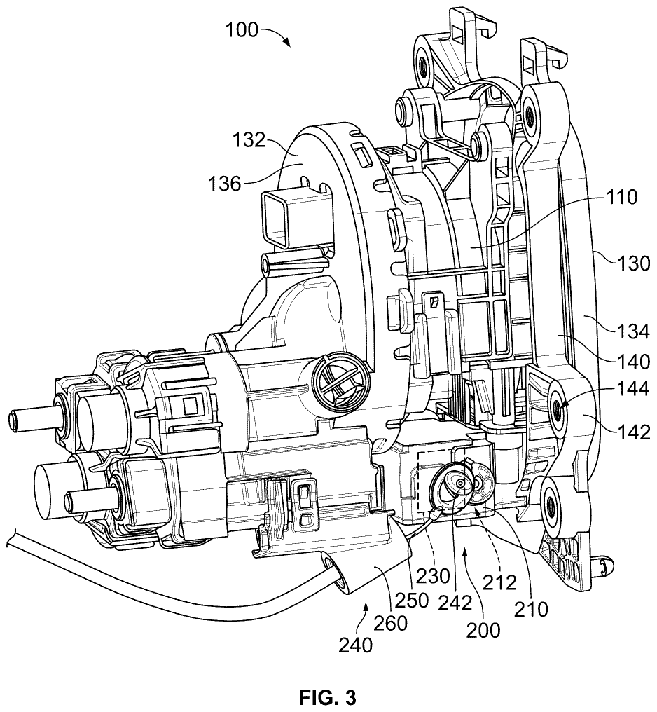

FIG. 1 is a front perspective view of a charging inlet assembly 100 in accordance with an exemplary embodiment. FIG. 2 is a rear perspective view of the charging inlet assembly 100 in accordance with an exemplary embodiment showing a manual release assembly 240 of a charging lock assembly 200 in a home or released position. FIG. 3 is a rear perspective view of the charging inlet assembly 100 in accordance with an exemplary embodiment showing the manual release assembly 240 of the charging lock assembly 200 in an emergency or pulled position.

The charging inlet assembly 100 is used as a charging inlet for a vehicle, such as an electric vehicle (EV) or hybrid electric vehicle (PHEV). The charging inlet assembly 100 is configured for mating reception with a charging connector, for example, a charging plug from a charging station (not shown). In an exemplary embodiment, the charging inlet assembly 100 is configured for mating with various types of charging connectors, such as an AC charger or a DC charger. The charging inlet assembly 100 may be a North American Charging System (NACS) charger, an SAE J1772 charger, a CCS1 charger, a CCS2 charger, or another type of charger.

The charging inlet assembly 100 includes a housing 110 configured to be mounted in the vehicle. The charging inlet housing 110 includes a charging socket 112 configured to receive the charging connector. The charging inlet housing 110 includes walls 114 in the charging socket 112 forming different pockets or terminal channels 116. The charging inlet housing 110 holds charging terminals 120 in the terminal channels 116.

In an exemplary embodiment, the charging terminals 120 may be AC charging terminals and/or DC charging terminals and/or ground terminals and/or proximity terminals and/or pilot terminals. Optionally, the charging terminals 120 may be different sized terminals. In an exemplary embodiment, the charging terminals 120 include pins 122 at mating ends of the charging terminals 120.

In an exemplary embodiment, power conductors 124 are terminated to the charging terminals 120. One or more of the power conductors 124 extend from the charging inlet assembly 100 to another component of the vehicle, such as the battery system of the vehicle. In various embodiments, the power conductors 124 may be power cables. In other various embodiments, the power conductors 124 may be busbars. The power conductors 124 may include circuits of a printed circuit board. In various embodiments, the power conductors 124 include AC conductors and DC conductors extending to different components of the vehicle. The power conductors 124 may extend straight away from the charging inlet housing 110 or may extend away from the charging inlet housing 110 at 90° (for example, right angle) or at other angles.

In an exemplary embodiment, an AC module of the charging inlet assembly 100 defines a low-voltage connector configured to be coupled to a low-voltage portion of the charging connectors. The AC module is configured to be coupled to other components in the system, such as a battery distribution unit, to control charging of the vehicle. The AC module may transmit/receive signals relating to charging, such as status of connection, status of charge, voltage of charge, and the like.

In an exemplary embodiment, a DC module of the charging inlet assembly 100 defines a high-voltage connector configured to be coupled to a high-voltage portion of the charging connector. The DC module is configured to be coupled to other components in the system, such as the battery and/or the battery distribution unit of the vehicle. The DC module may be used for fast charging of the battery.

The charging inlet housing 110 includes a front 130 and a rear 132. The front 130 of the housing 110 faces outward and is presented to the operator to connect the charging connector. The rear 132 faces the interior of the vehicle and is generally inaccessible without removing the charging inlet housing 110 from the vehicle. The charging inlet housing 110 includes a panel 134 at the front 130.

In an exemplary embodiment, the housing 110 includes a mounting flange 140 (FIG. 1) coupled to the panel 134 at the front 130. The mounting flange 140 includes mounting tabs 142 used for mounting the housing 110 to the vehicle. The mounting tabs 142 having openings 144 that receive fasteners (not shown) to secure the charging inlet assembly 100 to the vehicle. Other types of mounting features may be used to secure the charging inlet assembly 100 to the vehicle. The housing 110 and/or the mounting flange may include a seal to seal the charging inlet assembly 100 to the vehicle.

In various embodiments, the charging inlet assembly 100 may include a terminal cover (not shown) at the front of the charging inlet housing 110 to cover portions of the charging inlet housing 110. The charging inlet housing 110 may include one or more rear covers 136 at the rear of the housing 110 to close access to the rear of the charging inlet housing 110. The rear cover(s) 136 may be clipped or latched onto the main part of the housing 110, such as using clips or latches. Other types of securing features, such as fasteners, may be used in alternative embodiments.

In an exemplary embodiment, the charging inlet assembly 100 includes a charging lock assembly 200 configured to lock the charging connector to the charging inlet assembly 100 during charging. The charging lock assembly 200 includes a charging lock housing 210, a charging lock pin 220 held by the charging lock housing 210, and a charging lock actuator 230 operably coupled to the charging lock pin 220. The charging lock pin 220 is configured to lock the charging connector to the charging inlet assembly 100 during charging, such as to lock the charging connector in the charging socket 112. In an exemplary embodiment, the charging lock assembly 200 includes a manual release assembly 240 configured to manually release the charging lock pin 220.

The charging lock housing 210 may be coupled to the charging inlet housing 110. For example, the charging lock housing 210 may be secured to the charging inlet housing 110 using fasteners, latches, clips, or other securing elements. The charging lock housing 210 may be located at the rear 132, such as rearward of the panel 134. In the illustrated embodiment, the charging lock housing 210 is located at the bottom of the charging inlet housing 110. Other locations are possible in alternative embodiments. The charging lock housing 210 includes an interior cavity 212. The charging lock pin 220 may be held in the cavity 212. The charging lock pin 220 may pass through the charging inlet housing 110, such as into the charging socket 112, to interface with the charging connector. The charging lock actuator 230 may be held in the cavity 212.

The charging lock actuator 230 is operably coupled to the charging lock pin 220 to move the charging lock pin 220 between a locked position and an unlocked position. For example, the charging lock pin 220 may be moved into the charging socket 112, in the locked position, to interface with the charging connector to lock the charging connector in the charging socket 112. The charging lock pin 220 may be moved out of the charging socket 112, in the unlocked position, to allow removal of the charging connector from the charging socket 112. For example, the charging lock pin 220 may be recessed into the charging inlet housing 110 in the unlocked position. In an exemplary embodiment, the charging lock actuator 230 is an electric actuator. The charging lock actuator 230 may include an electric motor that is operated to extend and retract the charging lock pin 220. The charging lock actuator 230 may include a solenoid actuator that is operated to extend and retract the charging lock pin 220. Other types of actuators may be used in alternative embodiments.

In an exemplary embodiment, the manual release assembly 240 includes a manual release lever 242, a manual release cable 250, and a cable adapter 260. The cable adapter 260 supports the manual release cable 250. The cable adapter 260 positions the manual release cable 250, such as in alignment with the manual release lever 242 for proper actuation. The manual release lever 242 is configured to be operably coupled to the charging lock pin 220 to manually release the charging lock pin 220 from the locked position to the unlocked position, such as during an emergency operation when the charging lock assembly 200 does not properly unlock to release the charging connector (for example, when the charging lock actuator 230 fails). The manual release cable 250 is coupled to the manual release lever 242 to actuate the manual release lever 242. The manual release cable 250 may be manually pulled, such as rearward, to manually release the charging lock assembly 200. The manual release cable 250 may be routed to another area of the vehicle, such as to the trunk or interior compartment of the vehicle.

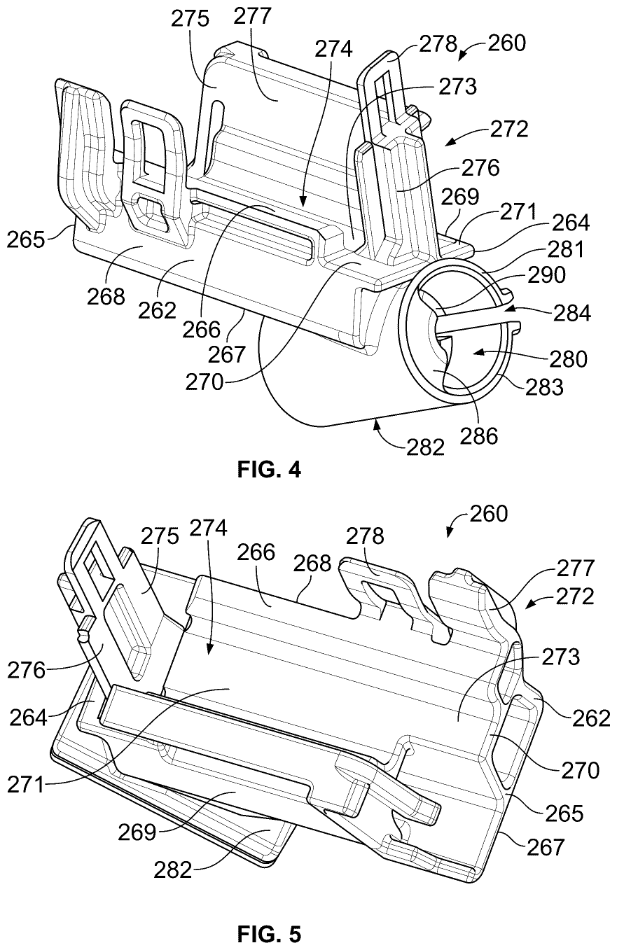

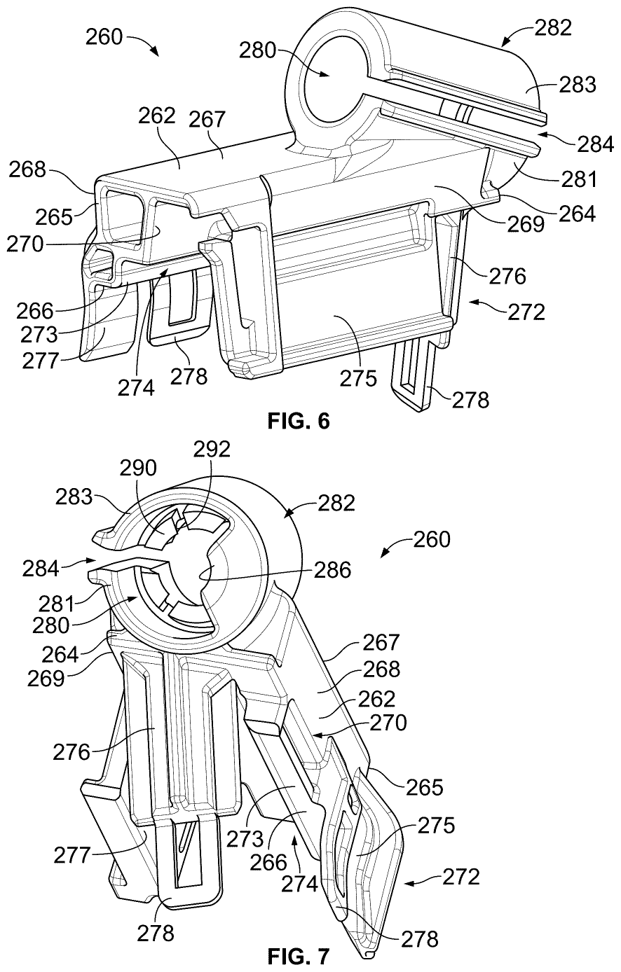

FIG. 4 is a top perspective view of a portion of the charging lock assembly 200 showing the cable adapter 260 in accordance with an exemplary embodiment. FIG. 5 is a top perspective view of the cable adapter 260 in accordance with an exemplary embodiment. FIG. 6 is a bottom perspective view of the cable adapter 260 in accordance with an exemplary embodiment. FIG. 7 is a front perspective view of the cable adapter 260 in accordance with an exemplary embodiment.

The cable adapter 260 is used to support and hold the manual release cable 250 relative to the charging lock housing 210 and/or the charging inlet housing 110 (both shown in FIGS. 2 and 3). In an exemplary embodiment, the cable adapter 260 is a dielectric body. For example, the cable adapter 260 may be manufactured from a plastic material. In an exemplary embodiment, the cable adapter 260 includes a molded plastic body 262. The cable adapter 260 is light-weight. The cable adapter 260 is rigid and retains shape over its lifetime. The cable adapter 260 may be designed to include features to accommodate the manual release cable 250 (for example, change in diameter to match diameter of the manual release cable 250) and/or to accommodate or fit into a mounting location or mount 214 (shown in FIGS. 2 and 3) on the charging lock housing 210 and/or the charging inlet housing 110 to fit within the system.

The cable adapter 260 extends between a front 264 and a rear 265. The cable adapter 260 includes an inner surface 266 at an inner end and an outer surface 267 at an outer end. The cable adapter 260 includes a first side 268 and a second side 269. The inner surface 266 is configured to face the mount 214 of the charging lock housing 210 and/or the charging inlet housing 110. For example, the inner end is configured to be mounted or coupled to the mount 214 of the charging lock housing 210 and/or the charging inlet housing 110. The inner surface 266 may be at a top of the cable adapter 260 and the outer surface 267 may be at the bottom of the cable adapter 260, or vice versa.

The cable adapter 260 includes a base 270 and a mounting bracket 272 extending from the base 270. The cable adapter 260 includes a cable channel 280 configured to receive the manual release cable 250. In an exemplary embodiment, the cable adapter 260 includes a cable support 282 extending from the base 270. The cable support 282 defines the cable channel 280. For example, the cable support 282 may extend at least partially around the cable channel 280 to hold the manual release cable 250 in the cable channel 280. In an exemplary embodiment, the mounting bracket 272 is provided at the inner end for mounting the cable adapter 260 to the mount 214 of the charging lock housing 210 and/or the charging inlet housing 110 and the cable support 282 is provided at the outer end 267 to receive the manual release cable 250.

The base 270 includes a mounting plate 271 having a mounting surface 273 configured to be mounted to the mount 214. The mounting surface 273 may be located at the inner end, such as at the top. The mounting bracket 272 extends from the mounting plate 271, such as above the mounting surface 273 to interface with the mount 214 of the charging lock housing 210 and/or the charging inlet housing 110.

In an exemplary embodiment, the mounting bracket 272 includes an alignment groove 274 along the inner surface 266 of the cable adapter 260. The alignment groove 274 may be formed in the mounting plate 271. The alignment groove 274 is configured to receive an alignment rail (not shown) of the mount 214, such as to position the mounting bracket 272 relative to the mount 214. The alignment groove 274 may control side-to-side positioning of the cable adapter 260 relative to the mount 214.

In an exemplary embodiment, the mounting bracket 272 includes one or more alignment walls 275 extending from the base 270. For example, the alignment walls 275 may extend from the top of the mounting plate 271. In an exemplary embodiment, the alignment walls 275 may include an end wall 276 at an end of the base 270, such as the front 264. The end wall 276 longitudinally positions the cable adapter 260 relative to the mount 214, such as front-to-rear. In an exemplary embodiment, the alignment walls 275 may include a side wall 277, such as at the first side 268 and/or the second side 269. The side wall 277 laterally positions the cable adapter 260 relative to the mount 214, such as side-to-side.

In an exemplary embodiment, the mounting bracket 272 includes one or more latches 278 configured to be latchably coupled to the mount 214 of the charging lock housing 210 and/or the charging inlet housing 110. The latches 278 may extend from the base 270. The latches 278 may be located above the mounting plate 271. The latches 278 may be deflectable, such as for latching and unlatching from a latching element of the mount 214. Optionally, the latch 278 may extend from the end wall 276 and/or the side wall 277. Other types of securing features may be used in alternative embodiments to secure the cable adapter 260 to the mount 214.

In an exemplary embodiment, the cable support 282 extends from the base 270. In the illustrated embodiment, the cable support 282 is at the outer end 267, such as at the bottom. The cable support 282 may be located at the front 264. In an exemplary embodiment, the cable support 282 is angled transverse relative to the base 270. For example, the cable channel 280 may be angled transverse to the base 270 (for example, the base 270 may be horizontal and the cable channel 280 may be angled). In an exemplary embodiment, the cable support 282 is curved, such as being generally cylindrical.

In an exemplary embodiment, the cable support 282 includes a first support wall 281 and a second support wall 283 forming the cable channel 280. The support walls 281, 283 are provided on opposite sides of the cable channel 280. The cable support 282 includes a cable slot 284 open to the cable channel 280. The cable slot 284 extends longitudinally along the cable adapter 260 between the front and the rear of the cable support 282. For example, the cable slot 284 is open at the front and the rear of the cable support 282. The cable slot 284 is open between the ends of the support walls 281, 283. For example, the support walls 281, 283 face each other across the cable slot 284. In an exemplary embodiment, the cable slot 284 is configured to receive the manual release cable 250. For example, the manual release cable 250 may be loaded into the cable channel 280 through the cable slot 284 (for example, side loading into the cable channel 280).

In an exemplary embodiment, the cable adapter 260 includes a stop wall 286 at the cable channel 280. The stop wall 286 is used to position the manual release cable 250 in the cable channel 280. The stop wall 286 may extend into the cable channel 280 from the first support wall 281 and/or the second support wall 283. The stop wall 286 may be provided at or near the front of the cable support 282.

In an exemplary embodiment, the cable adapter 260 includes retention latches 290 in the cable channel 280. The retention latches 290 are configured to engage the manual release cable 250 to hold the manual release cable 250 in the cable channel 280. In an exemplary embodiment, the retention latches 290 are deflectable latches. The retention latches 290 include latching fingers 292 at distal ends thereof. The latching fingers 292 may dig into the manual release cable 250 or may be received in a groove or slot in the manual release cable 250. The retention latches 290 may extend into the cable channel 280 from the first support wall 281 and/or the second support wall 283. The retention latches 290 may be provided at or near the front of the cable support 282. The retention latches 290 may be located rearward of the stop wall 286.

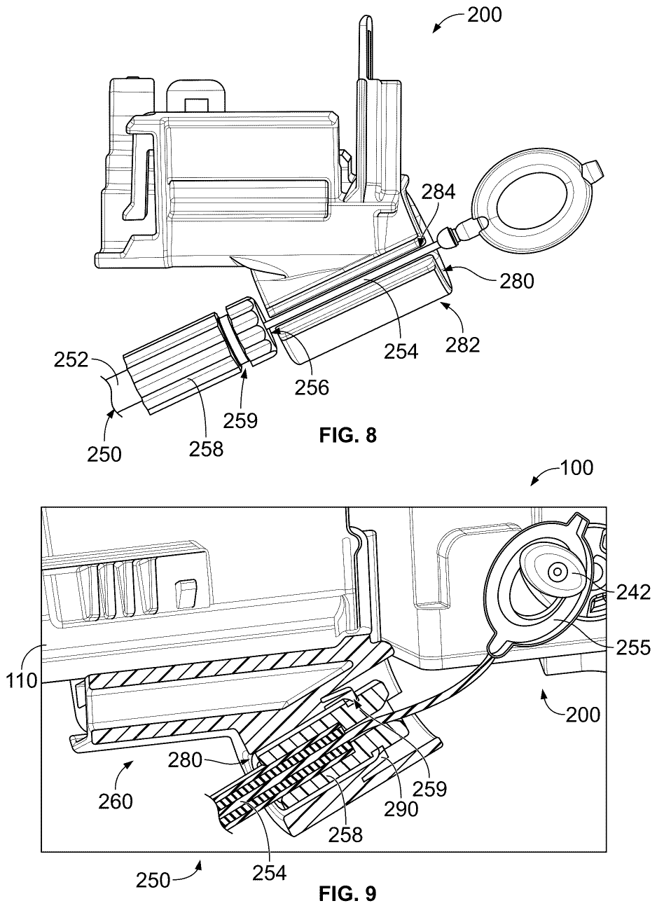

FIG. 8 is a side view of the charging lock assembly 200 in accordance with an exemplary embodiment. FIG. 8 shows the manual release cable 250 being loaded into the cable slot 284. The cable slot 284 is open at the side of the cable support 282 to allow loading of the manual release cable 250 into the cable channel 280 through the cable slot 284.

In an exemplary embodiment, the manual release cable 250 includes a cable sleeve 252 and an inner pull cable 254 received in a bore 256 of the cable sleeve 252. The inner pull cable 254 is movable relative to the cable sleeve 252. For example, the inner pull cable 254 may be pulled rearward in the cable sleeve 252 to pull the manual release lever 242, such as to release the charging lock pin 220. The cable sleeve 252 is configured to be received in the cable channel 280. In an exemplary embodiment, the manual release cable 250 includes a hosel 258 that receives the end of the cable sleeve 252. For example, the hosel 258 includes an inner bore 259 that receives the end of the cable sleeve 252. In an exemplary embodiment, the hosel 258 includes a one or more grooves 259 in the exterior of the hosel 258. For example, the groove 259 may be a circumferential groove 259 surrounding the hosel 258.

FIG. 9 is a sectional view of a portion of the charging inlet assembly 100 showing the charging lock assembly 200 coupled to the charging inlet housing 110. FIG. 9 shows the manual release cable 250 coupled to the cable adapter 260. The manual release cable 250 is loaded into the cable channel 280. For example, the hosel 258 is loaded into the cable channel 280. The hosel 258 may be positioned by the stop wall 286, such as to axially position the hosel 258 in the cable channel 280. In an exemplary embodiment, the retention latches 290 are latchably coupled to the hosel 258. For example, the retention latches 290 are received in the groove 259. The retention latches 290 axially position the hosel 258 in the cable channel 280. The retention latches 290 retain the hosel 258 in the cable channel 280.

In an exemplary embodiment, inner pull cable 254 extends forward from the hosel 258 and the cable adapter 260. The inner pull cable 254 is configured to interface with the manual release lever 242. In an exemplary embodiment, the end of the inner pull cable 254 includes an attachment element 255 configured to be attached to the manual release lever 242. In the illustrated embodiment, the attachment element 255 is a loop or ring having an opening receiving a portion of the manual release lever 242. The inner pull cable 254 is configured to pull against the manual release lever 242 to actuate the manual release lever 242.

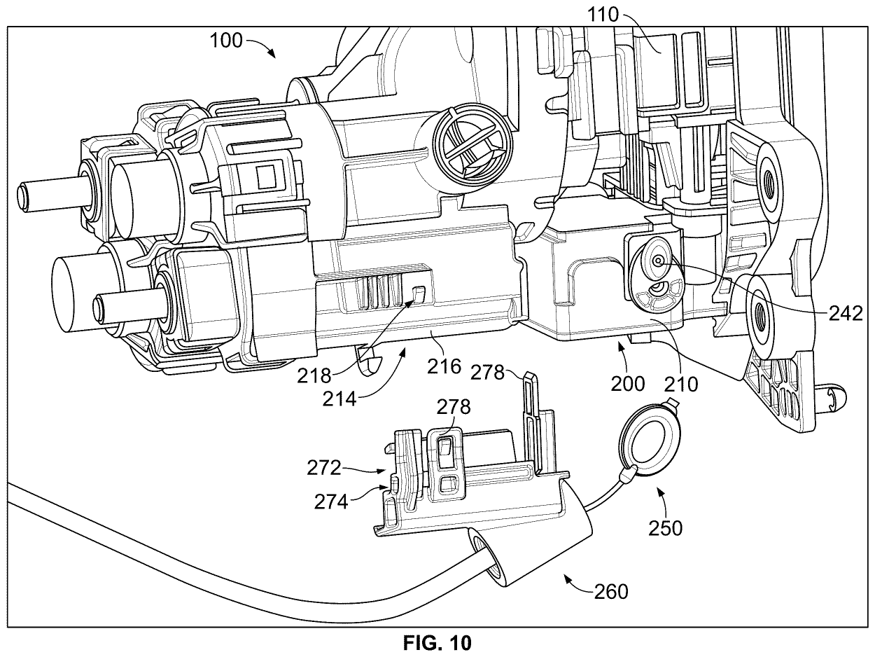

FIG. 10 is a side view of a portion of the charging inlet assembly 100 showing the charging lock assembly 200 poised for coupling to the mount 214. In the illustrated embodiment, the mount 214 is provided on the charging inlet housing 110. Alternatively, the mount 214 may be provided on the charging lock housing 210. The mount 214 is used to position the charging lock assembly 200, such as the manual release cable 250, relative to the manual release lever 242.

In an exemplary embodiment, the mount 214 includes an alignment rail 216. The alignment rail 216 is configured to be received in the alignment groove 274. The alignment rail 216 positions the cable adapter 260, such as longitudinally and/or laterally. In the illustrated embodiment, the alignment rail 216 is located at the bottom of the charging inlet housing 110.

In an exemplary embodiment, the mount 214 includes latches 218 for latchably securing the cable adapter 260 to the mount 214. The latches 218 may be provided at the sides and/or end walls of the charging inlet housing 110. The latches 218 may be fixed latches. Alternatively, the latches 218 may be deflectable latches. The latches 218 are configured to interface with the latches 278 of the mounting bracket 272 of the cable adapter 260. Other types of securing elements may be used in alternative embodiments, such as clips, fasteners, bands, and the like.

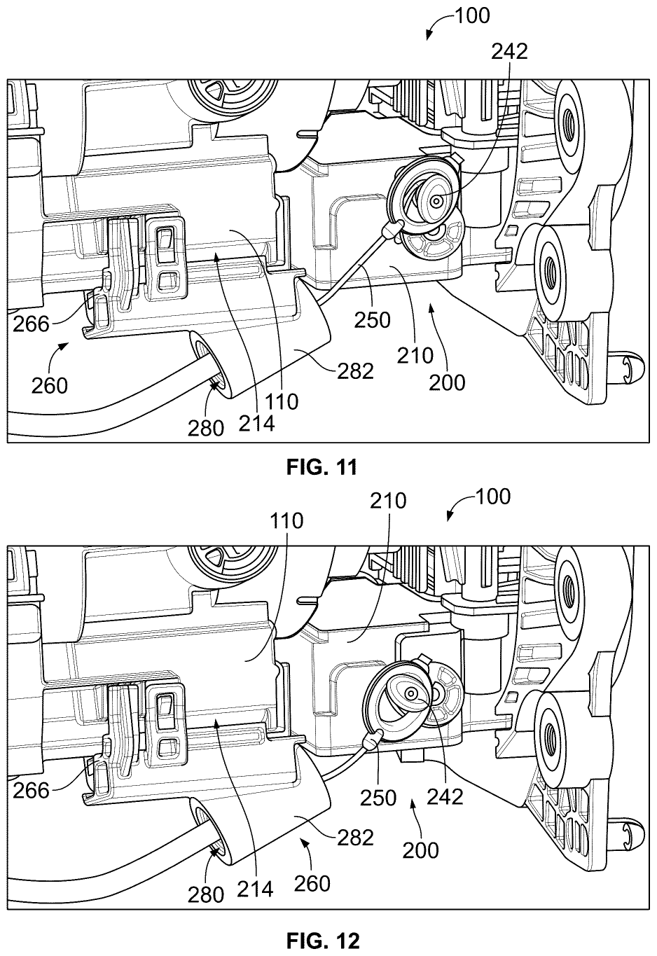

FIG. 11 is a side view of a portion of the charging inlet assembly 100 showing the manual release cable 250 of the charging lock assembly 200 in a home or released position. FIG. 12 is a side view of a portion of the charging inlet assembly 100 showing the manual release cable 250 of the charging lock assembly 200 in an emergency or pulled position. The manual release cable 250 is coupled to the manual release lever 242. The manual release cable 250 is pulled rearward to manually actuate the manual release lever 242, which releases the charging lock pin 220. In the illustrated embodiment, the manual release lever 242 is rotatably coupled to the charging lock housing 210.

In an exemplary embodiment, the inner surface 266 of the cable adapter 260 is coupled to the mount 214, such as at the charging inlet housing 110 or the charging lock housing 210. In an exemplary embodiment, the cable support 282, and the cable channel 280 therein, extend transverse to the inner surface 266 to orient the manual release cable 250 transverse to the inner surface 266. For example, cable support 282 is angled transverse to the inner surface 266 (for example, angled upward) to generally align the axis of the cable channel 280 with the manual release lever 242. As such, the manual release cable 250 is configured to extend generally straight outward from the cable adapter 260 (for example, parallel to the axis of the cable channel 280) to the manual release lever 242. As such, the pulling action on the manual release cable 250 pulls the manual release lever 242 along the transverse axis to actuate the manual release lever 242. As such, the manual release cable 250 does not bind and allows for smooth consistent operation.

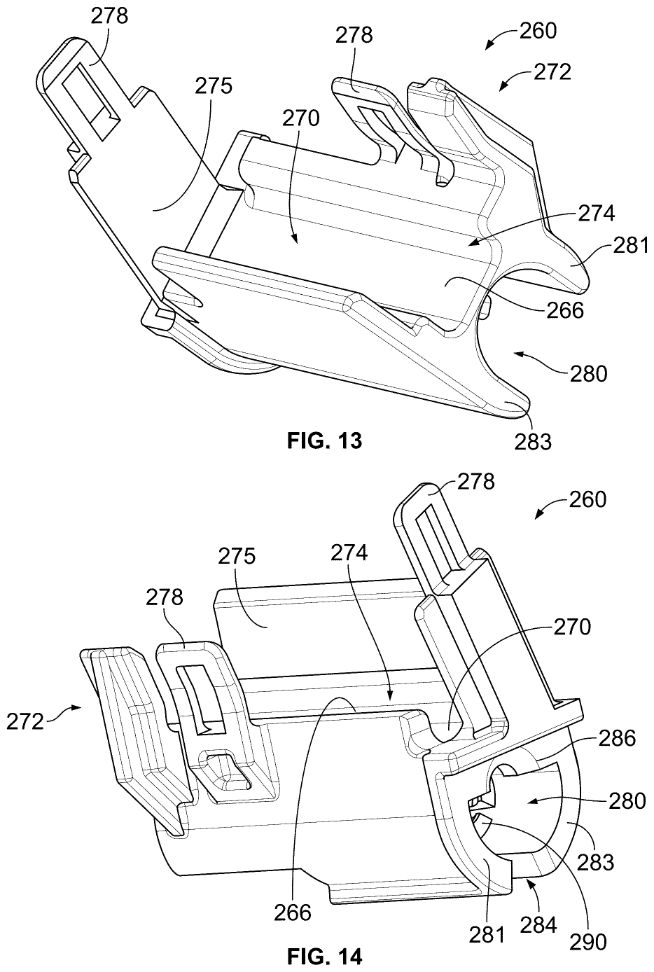

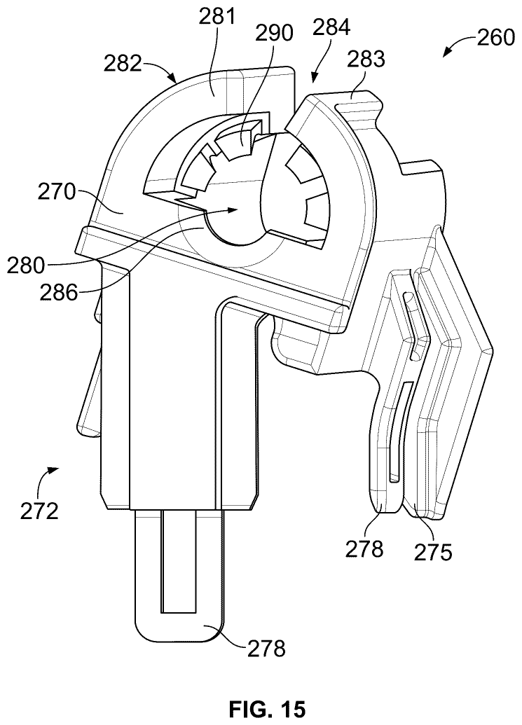

FIG. 13 is a top perspective view of the cable adapter 260 in accordance with an exemplary embodiment. FIG. 14 is a side perspective view of the cable adapter 260 in accordance with an exemplary embodiment. FIG. 15 is a front perspective view of the cable adapter 260 in accordance with an exemplary embodiment. The cable adapter 260 is similar to the cable adapter shown in FIGS. 4-7; however, the cable support 282 of the cable adapter 260 is parallel to the base 270 rather than being angle transverse to the base 270.

The cable adapter 260 includes the base 270 and the mounting bracket 272 extending from the base 270. The cable adapter 260 includes the cable support 282 extending from the base 270 forming the cable channel 280 configured to receive the manual release cable 250. The mounting bracket 272 includes the alignment groove 274 along the inner surface 266 of the cable adapter 260. The mounting bracket 272 includes the alignment walls 275 extending from the base 270. The mounting bracket 272 includes the latches 278.

In an exemplary embodiment, the cable support 282 extends from the base 270. For example, the first and second support walls 281, 283 extend from the bottom of the base 270 to form the cable channel 280. In the illustrated embodiment, the cable channel 280 extends along an axis that is parallel to base 270, such as being parallel to the inner surface 266. For example, the base 270 and the cable channel 280 may extend generally horizontally. The cable slot 284 is open to the cable channel 280. The cable adapter 260 includes the stop wall 286 at the cable channel 280. The cable adapter 260 includes the retention latches 290 in the cable channel 280.

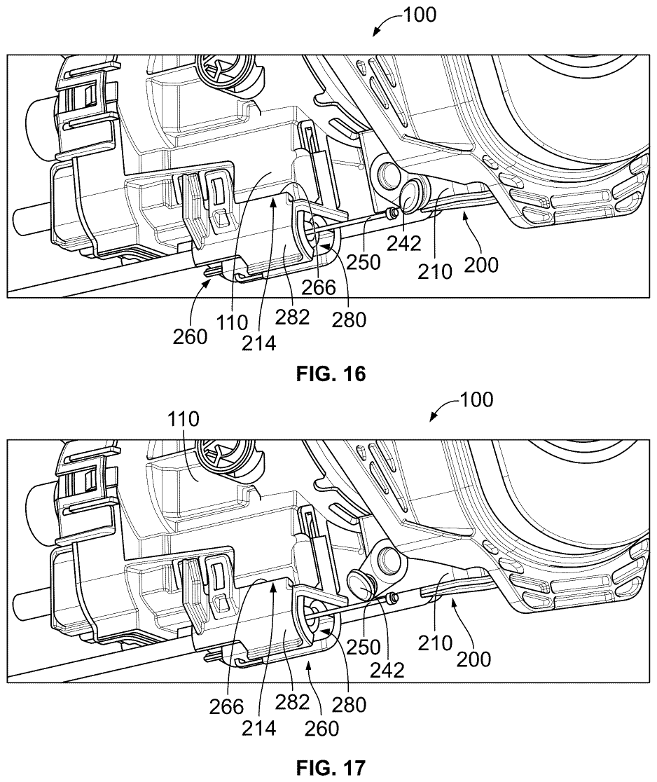

FIG. 16 is a side view of a portion of the charging inlet assembly 100 showing the manual release cable 250 of the charging lock assembly 200 in a home or released position. FIG. 17 is a side view of a portion of the charging inlet assembly 100 showing the manual release cable 250 of the charging lock assembly 200 in an emergency or pulled position. The manual release cable 250 is coupled to the manual release lever 242. The manual release cable 250 is pulled rearward to manually actuate the manual release lever 242, which releases the charging lock pin 220. In the illustrated embodiment, the manual release lever 242 is rotatably coupled to the charging lock housing 210.

In an exemplary embodiment, the inner surface 266 of the cable adapter 260 is coupled to the mount 214, such as at the charging inlet housing 110 or the charging lock housing 210. In an exemplary embodiment, the cable support 282, and the cable channel 280 therein, extend parallel to the inner surface 266 to orient the manual release cable 250 parallel to the inner surface 266. The manual release cable 250 is configured to extend generally straight outward from the cable adapter 260 (for example, parallel to the axis of the cable channel 280) to the manual release lever 242. As such, the pulling action on the manual release cable 250 pulls the manual release lever 242 along the axis to actuate the manual release lever 242.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

What is claimed is:

1. A charging lock assembly for a charging inlet assembly of a vehicle, the charging lock assembly comprising:
a charging lock housing having a cavity;
a charging lock pin in the cavity of the charging lock housing, the charging lock pin configured to lock a charging connector to the charging inlet assembly during charging;
a charging lock actuator operably coupled to the charging lock pin configured to move the charging lock pin between a locked position and an unlocked position; and
a release assembly including a release lever operably coupled to the charging lock pin to release the charging lock pin from the locked position to the unlocked position, the release assembly including a release cable coupled to the release lever to actuate the release lever, and the release assembly including a cable adapter supporting the release cable, the cable adapter having a cable channel receiving the release cable.

2. The charging lock assembly of claim 1, wherein the cable adapter includes a molded plastic body.

3. The charging lock assembly of claim 1, wherein the cable channel extends along an axis generally aligned with the release lever to align an end of the release cable with the release lever.

4. The charging lock assembly of claim 1, wherein the cable adapter includes a cable slot open to the cable channel, the release cable being loaded into the cable channel through the cable slot.

5. The charging lock assembly of claim 4, wherein the cable slot extends longitudinally along the cable adapter between a front and a rear of the cable adapter.

6. The charging lock assembly of claim 1, wherein the release cable includes a hosel receiving an end of the release cable, the hosel being received in the cable channel to position the release cable relative to the cable adapter.

7. The charging lock assembly of claim 1, wherein the cable adapter includes a base and a mounting bracket extending from the base, the mounting bracket being coupled to a mount of one of the charging lock housing or a charging inlet housing of the charging inlet assembly.

8. The charging lock assembly of claim 7, wherein the mounting bracket includes a latch being latchably coupled to the mount.

9. The charging lock assembly of claim 7, wherein the mounting bracket includes an end wall and a side wall perpendicular to the end wall, the end wall longitudinally positioning the cable adapter relative to the mount, the side wall laterally positioning the cable adapter relative to the mount.

10. The charging lock assembly of claim 1, wherein the cable adapter includes an alignment groove along the inner surface of the cable adapter, the alignment groove configured to receive an alignment rail of a mount of one of the charging lock housing or a charging inlet housing of the charging inlet adapter.

11. The charging lock assembly of claim 1, wherein the cable adapter includes a stop wall at the cable channel configured to position the release cable in the cable channel.

12. The charging lock assembly of claim 1, wherein the cable adapter includes retention latches in the cable channel configured to engage the release cable to hold the release cable in the cable channel.

13. The charging lock assembly of claim 1, wherein the release cable includes a cable sleeve and an inner pull cable received in a bore of the cable sleeve, the cable sleeve being received in the cable channel, the inner pull cable being movable in the cable sleeve to pull the release lever to release the charging lock pin.

14. The charging lock assembly of claim 1, wherein the release lever is rotatably coupled to the charging lock housing.

15. The charging lock assembly of claim 1, wherein the cable adapter includes an inner surface coupled to one of the charging lock housing or a charging inlet housing of the charging inlet assembly, the cable channel extending parallel to the inner surface to orient the release cable parallel to the inner surface.

16. The charging lock assembly of claim 1, wherein the cable adapter includes an inner surface coupled to one of the charging lock housing or a charging inlet housing of the charging inlet assembly, the cable channel extending transverse to the inner surface to orient the release cable transverse to the inner surface.

17. A charging inlet assembly comprising:
a charging inlet housing having a front and a rear, the charging inlet housing having terminal channels between the front and the rear, the charging inlet housing configured to be coupled to a charging connector at the front;
charging terminals received in the corresponding terminal channels and held in the charging inlet housing, the charging terminals having mating ends and terminating ends, the terminating ends configured to be electrically coupled to corresponding power cables, the mating ends including pins configured to be connected to the charging connector; and
a charging lock assembly configured to lock the charging connector to the charging inlet assembly during charging, the charging lock assembly including a charging lock housing coupled to the charging inlet housing and having a cavity, the charging lock assembly including a charging lock pin in the cavity of the charging lock housing, the charging lock pin configured to lock the charging connector to the charging inlet assembly during charging, the charging lock assembly including a charging lock actuator operably coupled to the charging lock pin configured to move the charging lock pin between a locked position and an unlocked position, the charging lock assembly including a release assembly including a release lever operably coupled to the charging lock pin to release the charging lock pin from the locked position to the unlocked position, the release assembly including a release cable coupled to the release lever to actuate the release lever, the release assembly including a cable adapter supporting the release cable, the cable adapter including a cable channel receiving the release cable.

18. A release assembly for releasing a charging lock pin used to lock a charging connector to a charging inlet assembly during a charging operation, the release assembly comprising:
a release lever movable between an unactuated position and an actuated position, the release lever configured to be operably coupled to the charging lock pin to release the charging lock pin from a locked position to an unlocked position as the release lever is moved from the unactuated position to the actuated position;
a release cable coupled to the release lever to actuate the release lever; and
a cable adapter supporting the release cable, the cable adapter including a cable channel receiving the release cable, the cable adapter positioning the release cable relative to the release lever.

19. The release assembly of claim 18, wherein the cable adapter includes a molded plastic body.

20. The release assembly of claim 18, wherein the cable channel extends along an axis generally aligned with the release lever to align an end of the release cable with the release lever.
